(19) United States
(12) Patent Application Publication
(10) Pub. No.: US 2025/0363221 A1
(43) Pub. Date: Nov. 27, 2025

(54) COMPUTER SYSTEMS, METHODS, AND DEVICES FOR ANALYZING EXPLOITABILITY OF MEMORY SAFETY VULNERABILITIES

(71) Applicant: RunSafe Security, Inc., McLean, VA (US)

(72) Inventors: Doug Britton, Kensington, MD (US); Shane Paulsen Fry, Madison, AL (US)

(21) Appl. No.: 19/214,931

(22) Filed: May 21, 2025

Related U.S. Application Data
(60) Provisional application No. 63/650,686, filed on May 22, 2024.

(51) Int. Cl. G06F 21/57

(52) U.S. Cl. CPC G06F 21/577; G06F 2221/034

(57) ABSTRACT

The present disclosure provides a method for analyzing exploitability of memory safety vulnerabilities in binary programs. The method includes identifying potential vulnerabilities within a binary program, performing a baseline analysis to detect potential Return-Oriented Programming (ROP) chains, applying a memory safety mitigation technology to the binary program, performing a protected analysis after applying the memory safety mitigation technology to detect potential ROP chains, comparing results of the baseline analysis and the protected analysis, and generating a report quantifying an impact of the memory safety mitigation technology on exploitability of the identified vulnerabilities. The method enables assessment of the effectiveness of memory safety mitigation techniques in reducing the risk of exploitation, providing valuable insights for improving software security throughout the development lifecycle.

### PRIORITY

The present application claims the benefit under 35 U.S.C. § 119 (e) of U.S. Provisional Application No. 63/650,686 filed May 24, 2024, which is hereby incorporated herein by reference in its entirety under 37 C.F.R. § 1.57. Any and all applications for which a foreign or domestic priority claim is identified in the Application Data Sheet as filed with the present application are hereby incorporated by reference under 37 C.F.R. § 1.57.

### FIELD

The present disclosure relates to cybersecurity risk analysis, and more particularly to a method and system for analyzing the exploitability of memory safety vulnerabilities in binary programs.

### BACKGROUND

In computer programming, memory safety refers to a set of principles and mechanisms designed to prevent errors related to the incorrect handling of memory, which can lead to software vulnerabilities and bugs. Ensuring memory safety involves managing how memory is accessed and manipulated during program execution to protect against common issues such as buffer overflows, use-after-free errors, and memory leaks. These issues create an opportunity which may be utilized by hackers to cause severe vulnerabilities in a computer system, such as crashes, data corruption, remote code execution, and security breaches.

Two prominent examples of hackers exploiting these vulnerabilities include the WannaCry Ransomware Attack and the Equifax Data Breach. The WannaCry ransomware attack exploited a vulnerability in older Windows operating systems, which utilized a buffer overflow in the Windows SMB protocol. This attack allowed the ransomware to spread rapidly across networks, locking users out of their systems and demanding ransom payments from hundreds of thousands of computers across 150 countries. The Equifax Data Breach, one of the largest in history, involved the exposure of sensitive data of approximately 147 million people. The breach was made possible by exploiting a vulnerability in Apache Struts, an open-source web application framework for Java web applications. The specific vulnerability allowed attackers to execute arbitrary code on the server by exploiting a security flaw where untrusted data was used to reconstruct an executable object.

As shown, the implications of memory safety vulnerabilities are far-reaching and can have dire consequences in terms of both security and system stability. Therefore, understanding and mitigating these risks are essential for developing robust, secure software. There are currently no good ways to measure or assess the risk that a binary can be exploited by memory safety vulnerabilities.

To assess the risks relating to memory safety vulnerabilities of a program or binary when loaded into working memory (the volatile random-access memory serving both the operating system and all active process's code and data), there are two separate stages of risk assessment that need to be examined. The question posed by the first stage of the risk assessment is whether there is a vulnerability in the code that would allow an attacker to either add unauthorized information into the working memory of the program or manipulate existing information of the program. The second stage in the analysis involves analyzing whether actions may be taken due to the vulnerability and if they can be manipulated into unauthorized action on the part of the program.

When unauthorized actions are utilized for unintended purposes, this action is typically called “exploiting a vulnerability” or “weaponizing a vulnerability.” If a program has zero memory safety vulnerabilities (i.e., no vulnerabilities exist in the program), it cannot be targeted for exploitation. If the program has vulnerabilities, but there are zero ways of exploiting the vulnerabilities, the program cannot be exploited. But, if the program has both vulnerabilities and ways of exploiting the vulnerabilities, the program can become a tool for attackers to gain access to the system.

The cybersecurity industry currently focuses on reducing risk by removing vulnerabilities. The problem with this approach is that testing for vulnerabilities has proven to be extremely difficult. Many programs have been tested thousands of times over decades, only to still have new vulnerabilities discovered.

Some technologies have attempted to reduce the exploitability of a program or binary, regardless of the vulnerability. Technologies like Address Space Layout Randomization try to obscure the internals of the binary in a way that obscures memory contents, thereby complicating exploitation. Unfortunately, these methods have not slowed the advance of reliable, scalable memory safety exploitation. If no attention is given to reducing the ability to weaponize or exploit memory safety vulnerabilities, organizations will have an unjustified sense of confidence in their infrastructure.

### BRIEF DESCRIPTION OF THE DRAWINGS

These and other features, aspects, and advantages of the present disclosure are described with reference to drawings of certain implementations, which are intended to illustrate, but not to limit, the present disclosure. It is to be understood that the attached drawings are for the purpose of illustrated concepts disclosed in the present disclosure and may not be to scale.

FIG. 1 illustrates an example memory safety exploitation analogy system to aid in the understanding of a Return Oriented Programming (ROP) attack by a hacker according to some implementations herein.

FIG. 2 illustrates an example sample program being targeted by a ROP chain attack according to some implementations herein.

FIG. 3 illustrates an example risk analysis diagram and method using ROP chain detection to assess the effectiveness of memory safety mitigation technology according to some implementations herein.

FIG. 4 illustrates a risk analysis method using ROP chain detection and function leakage detection to assess the effectiveness of memory safety mitigation technology according to some implementations herein.

FIG. 5 illustrates an example of the results of an exploitation risk assessment integrated into the development process and in the generation of a software BOM according to some implementations herein.

FIG. 6 is a system diagram illustrating an example of a computing environment in which the disclosed system operates in some embodiments of the present technology.

FIG. 7 is a system diagram illustrating an example of a computing environment in which the disclosed system operates in some embodiments.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### SUMMARY

For purposes of this summary, certain aspects, advantages, and novel features of the invention are described herein. It is to be understood that not all such advantages necessarily may be achieved in accordance with any particular implementation of the invention. Thus, for example, those skilled in the art will recognize that the invention may be embodied or carried out in a manner that achieves one advantage or group of advantages as taught herein without necessarily achieving other advantages as may be taught or suggested herein.

Some implementations are directed to a computer-implemented method for determining exploitability of memory safety vulnerabilities, the computer-implemented method comprising: analyzing, by a computer system, a first executable by scanning a binary of the first executable to identify one or more first sequences of instructions ending with a return instruction, each first sequence of instructions situated at a fixed memory address; analyzing, by the computer system, the one or more sequences of machine instructions to detect one or more usable sequences in a Return Oriented Programming (ROP) chain; monitoring, by the computer system, a second executable during runtime of the second executable to identify at least one pattern corresponding to a known or suspected ROP chain, wherein the second executable comprises the first executable augmented with code comprising one or more memory safety mitigation technologies; identifying, by the computer system based at least in part on the at least one pattern, one or more second sequences of instructions during runtime of the second executable; comparing, by the computer system, the one or more first sequences with the one or more second sequences; calculating, by the computer system based on the comparison, a change in exploitation risk between the first executable and the second executable; and generating, by the computer system, a report including the calculated change in exploitation risk between the first executable and the second executable, wherein the computer system comprises a processor and a memory.

In some implementations, the monitoring of the second executable comprises instrumenting a code of the second executable or using hardware features to log memory and/or register accesses of the second executable. In some implementations, the one or more memory safety mitigation technologies comprises Load-time Function Randomization (LFR).

In some implementations, the method further comprises converting the calculated change in exploitation risk into a rating. In some implementations, the method further comprises identifying one or more dynamically generated addresses that point to a function within the first executable; and determining whether there is a code flow path through the first executable that would allow the one or more dynamically generated addresses to be passed outside of the first executable. In some implementations, the method further comprises identifying one or more dynamically generated addresses that point to a function within the second executable; and determining whether there is a code flow path through the first executable that would allow the one or more dynamically generated addresses to be passed outside of the second executable.

In some implementations, one or more of the method steps are repeated multiple times to provide Monte Carlo-type results. In some implementations, the method further comprises the report comprises a number of the one or more first sequences and a number of the one or more second sequences. In some implementations, the method further comprises including the report in a software bill of materials (SBOM).

Some implementations are directed to a system, comprising at least one hardware processor; and at least one non-transitory memory storing instructions that, when executed by the at least one hardware processor, cause the system to: analyze a first executable by scanning a binary of the first executable to identify one or more first sequences of instructions ending with a return instruction, each first sequence of instructions situated at a fixed memory address; analyze the one or more sequences of machine instructions to detect one or more usable sequences in a Return Oriented Programming (ROP) chain; monitor a second executable during runtime of the second executable to identify at least one pattern corresponding to a known or suspected ROP chain, wherein the second executable comprises the first executable augmented with code comprising one or more memory safety mitigation technologies; identify, based at least in part on the at least one pattern, one or more second sequences of instructions during runtime of the second executable; compare the one or more first sequences with the one or more second sequences; calculate based on the comparison, a change in exploitation risk between the first executable and the second executable; and generate a report including the calculated change in exploitation risk between the first executable and the second executable.

In some implementations, the system is further caused to include the report in a software bill of materials (SBOM).

Some implementations herein are directed to a non-transitory, computer-readable storage medium comprising instructions recorded thereon, wherein the instructions, when executed by at least one data processor of a system, cause the system to: analyze a first executable by scanning a binary of the first executable to identify one or more first sequences of instructions ending with a return instruction, each first sequence of instructions situated at a fixed memory address; analyze the one or more sequences of machine instructions to detect one or more usable sequences in a Return Oriented Programming (ROP) chain; monitor a second executable during runtime of the second executable to identify at least one pattern corresponding to a known or suspected ROP chain, wherein the second executable comprises the first executable augmented with code comprising one or more memory safety mitigation technologies; identify, based at least in part on the at least one pattern, one or more second sequences of instructions during runtime of the second executable; compare the one or more first sequences with the one or more second sequences; calculate based on the comparison, a change in exploitation risk between the first executable and the second executable; and generate a report including the calculated change in exploitation risk between the first executable and the second executable.

In some implementations, the monitoring of the second executable comprises instrumenting a code of the second executable or using hardware features to log memory and/or register accesses of the second executable. In some implementations, the one or more memory safety mitigation technologies comprises Load-time Function Randomization (LFR). In some implementations, the system is further caused to convert the calculated change in exploitation risk into a rating.

In some implementations, the system is further caused to: identify one or more dynamically generated addresses that point to a function within the first executable; and determine whether there is a code flow path through the first executable that would allow the one or more dynamically generated addresses to be passed outside of the first executable.

In some implementations, the system is further caused to: identify one or more dynamically generated addresses that point to a function within the second executable; and determine whether there is a code flow path through the first executable that would allow the one or more dynamically generated addresses to be passed outside of the second executable.

In some implementations, one or more of the steps are repeated multiple times to provide Monte Carlo-type results. In some implementations, the report comprises a number of the one or more first sequences and a number of the one or more second sequences. In some implementations, the system is further caused to include the report in a software bill of materials (SBOM).

The implementations herein are generally directed to solving the challenges and methodologies associated with assessing the risks of memory safety vulnerabilities in binary programs. Further introduced are concepts of the risk assessment integrated into software development and maintenance processes, software bill of materials reporting, and assessment of memory safety mitigation techniques such as address space layout randomization (ASLR).

### DETAILED DESCRIPTION

Although several implementations, examples, and illustrations are disclosed below, it will be understood by those of ordinary skill in the art that inventions described herein extend beyond the specifically disclosed implementations, example, and illustrations and includes other uses of inventions obvious modifications and equivalents thereof. Implementations of the inventions are described with reference to accompanying figures, wherein like numerals refer to the like elements throughout. The terminology used in the description presented herein is not intended to be interpreted in any limited or restrictive manner simply because it is being used in conjunction with a detailed description of certain specific implementations of the inventions. In addition, implementations of the inventions can comprise several novel features and no single feature is solely responsible for its desirable attributes or is essential to practicing the inventions herein described.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

In recent years, cybersecurity has become an increasingly critical concern for organizations and individuals alike. As technology continues to advance, so do the methods and techniques employed by malicious actors seeking to exploit vulnerabilities in computer systems. Among the various types of vulnerabilities, memory safety issues have emerged as a particularly challenging problem in software development and security.

Memory safety vulnerabilities arise from improper handling of memory in computer programs, often occurring in languages that allow direct memory manipulation such as C and C++. These vulnerabilities can lead to severe consequences, including system crashes, data corruption, and unauthorized access to sensitive information. Common examples of memory safety issues include buffer overflows, use-after-free errors, and null pointer dereferences, among others. The exploitation of memory safety vulnerabilities has been a persistent threat in the cybersecurity landscape. Attackers have developed sophisticated techniques to take advantage of these weaknesses, such as Return-Oriented Programming (ROP) and Jump-Oriented Programming (JOP). These methods allow malicious actors to execute arbitrary code on a target system by chaining together small snippets of existing code, known as gadgets, in unintended ways.

Traditionally, efforts to mitigate memory safety risks have focused on identifying and patching vulnerabilities through various testing methodologies and code analysis tools. However, this approach has limitations, as it is often challenging to discover all potential vulnerabilities in complex software systems. Additionally, the time between vulnerability discovery and patch deployment can leave systems exposed to attacks. To address these challenges, researchers and security professionals have developed various runtime protection mechanisms and compiler-based techniques. These include Address Space Layout Randomization (ASLR), which randomizes the memory addresses of program components to make exploitation more difficult, and Control Flow Integrity (CFI), which aims to prevent attackers from hijacking program execution. Despite these advancements, assessing the overall risk posed by memory safety vulnerabilities in a given binary program remains a complex task. Current methodologies often focus on identifying specific vulnerabilities rather than evaluating the broader exploitability of a program. This leaves a gap in understanding the true security posture of software systems, particularly in the face of zero-day vulnerabilities that have not yet been discovered or disclosed.

As the reliance on software continues to grow across all sectors of society, there is an increasing need for comprehensive tools and methodologies that can provide a more nuanced understanding of memory safety risks. Such approaches would enable developers, system administrators, and security professionals to make more informed decisions about software deployment, prioritize security efforts, and allocate resources more effectively in the ongoing battle against cyber threats.

The implementations herein are therefore generally directed to approaches for analyzing and quantifying the exploitability of memory safety vulnerabilities in binary programs, often those developed in native programming languages (e.g., C, C++, Ada). The disclosed methods and systems provide a comprehensive framework for evaluating the risk of exploitation, both before and after the application of memory safety mitigation techniques. The technical improvements brought forth by the implementations herein are multifaceted. Firstly, the methods enable a more granular and accurate assessment of exploitation risk, moving beyond traditional vulnerability detection to focus on the practical exploitability of identified vulnerabilities. This shift in focus allows for a more nuanced understanding of the actual security posture of a given binary program. Secondly, the implementations herein introduce a systematic approach to quantifying the effectiveness of memory safety mitigation technologies. By comparing the exploitability of a binary before and after the application of such technologies, the methods and systems provide concrete metrics for assessing the impact of security measures. This quantitative approach enables more informed decision-making in the selection and implementation of security strategies. Furthermore, the disclosed implementations integrate seamlessly with existing software development lifecycles and bill of materials (BOM) processes, allowing for continuous risk assessment throughout the development process, and enabling early detection and mitigation of potential security issues. The ability to incorporate exploitation risk analysis into software BOMs also enhances transparency and facilitates more comprehensive security evaluations of software components.

The implementations herein represent a practical application of advanced program analysis techniques to address real-world cybersecurity challenges. By providing a tool for assessing the second stage of exploitation risk—the risk of weaponizing a vulnerability rather than merely identifying its presence—the method fills a critical gap in current security practices. This approach therefore offers tangible improvements to computer technology and cybersecurity practices. The disclosed system may adapt to various memory safety mitigation technologies and provide comparative analyses, providing flexibility and broad applicability across different computing environments and security contexts. Thus, the implementations herein provide a technical solution to the complex problem of assessing and mitigating memory safety vulnerabilities in binary programs. By providing a practical, quantifiable approach to exploitation risk analysis, the implementations herein offer significant advancements in the field of cybersecurity, enhancing the ability of developers, system administrators, and security professionals to protect computer systems against sophisticated attacks.

In some implementations, the systems and methods herein are used to identify and quantitatively assess the risks involved with software memory safety vulnerabilities existing in a program or binary when loaded into a working memory for execution. While the cybersecurity industry currently focuses on identification of memory safety vulnerabilities, the implementations presented herein focus on evaluating and quantifying the risk that these vulnerabilities may be exploited. Further disclosed are methods for assessing the risk on a binary subsequent to employing vulnerability defense mechanisms such as ASLR.

### Return Oriented Programming (ROP) Attacks

In modern computer systems, hackers are typically limited in their ability to add arbitrary instructions into memory due to operating systems and hardware protections, such as Data Execution Prevention (DEP) and the No-Execute bit (NX). As such, hackers must determine how to misuse the instructions that are already in memory. A common method to gain control over a system is a ROP attack. A ROP attack involves stringing together a series of sequential instructions that legitimately exist in memory already, manipulating the flow of the binary execution. This series of instructions are collectively known as a ROP Chain (Return-Oriented Programming Chain) and the instructions are arranged to execute a series of operations that together perform a malicious or unintended action. The attack gets its name, Return-Oriented Programming, as the instructions will call small sequences of machine code, known as gadgets, existing in the binary that end with a return instruction which may be found within the existing code of the binary or its libraries. Each gadget performs a specific operation like loading a register, performing an arithmetic operation, or calling a function, among others. ROP is related to but distinct from JOP, with the latter utilizing jump or call instructions instead of returns. The nomenclature presented here, such as referring to gadgets as ROP gadgets, may be understood to have a corresponding terminology such as JOP gadgets.

ROP programming begins by exploiting a memory safety vulnerability. A common vulnerability is a buffer overflow. This occurs when a program writes more data to a buffer than it can hold, which can corrupt data, crash the program, or allow execution of malicious code. Other vulnerabilities which may enable the opportunity for program weaponization include use-after-free, memory leaks, dangling pointers, and improper synchronization, among others. Use-after-free refers to accessing memory after it has been freed and can lead to unpredictable behavior or allow attackers to exploit the freed memory to execute arbitrary code. Memory leaks occur when a program fails to release memory that is no longer needed, which can lead to a gradual increase in used memory, eventually causing the system to slow down or crash. Dangling pointers are a condition where a pointer still refers to a memory location that has been freed, and the use of these pointers can lead to corrupt data or crashes. Improper synchronization exists in concurrent executions of a binary where multiple processes access and modify the same memory concurrently, causing a race condition and leading to inconsistent or corrupt state. Once a memory vulnerability, such as a buffer overflow, has been identified, a hacker may proceed with an attack via the example methodology of identifying gadgets, constructing the ROP chain, triggering the vulnerability, setting up the stack to call the gadgets, and executing the ROP chain. ROP attacks are particularly useful for bypassing protections like DEP (Data Execution Prevention) and ASLR. By using code that is already present in the memory, ROP doesn't need to introduce new executable code. For ASLR, gadgets are often sourced from libraries or binaries that are either not randomized or have their addresses leaked via another vulnerability. A high-level overview of the steps a hacker takes to execute a ROP attack is presented herein for exemplary purposes.

The first step in building a ROP chain is to find useful gadgets within the binary or loaded libraries of the application. These gadgets are typically short sequences of machine instructions that end with a return (“ret”) instruction. The gadgets are used to perform specific tasks like moving data, manipulating registers, performing arithmetic, or calling functions, among others. Tools like ROPgadget, radare2, or IDA Pro can be used to automate the search for these gadgets. Once suitable gadgets are identified, the attacker constructs a ROP chain. This may involve arranging the addresses of these gadgets in the payload such that when the first gadget executes and reaches its RET instruction, the stack pointer (e.g., Extended Stack Pointer (“esp”) or Register: Stack Pointer (“rsp”)) points to the next gadget's address. This sequence continues, allowing the attacker to ‘chain’ together multiple gadget executions to perform arbitrary operations. The specific order and selection of gadgets depend on the intended outcome of the exploit. With the gadgets identified and the chain constructed, the attacker then needs to trigger the buffer overflow. This involves inputting data into the buffer that exceeds its boundary and strategically overwrites the stack data, particularly the return address or other control data, to point to the first gadget in the ROP chain. The overflow must overwrite the return address of the current function (or another control data like function pointers or exception handlers) to point to the first gadget in the ROP chain. The payload must be carefully crafted not just with the gadget addresses but also with any necessary “filler” data that gadgets expect to find in registers or on the stack. For instance, many gadgets rely on specific register values as parameters, which can be set by previous gadgets in the chain or by carefully positioning values on the stack that gadgets pop into registers. Once the overflow is triggered and the overwritten return address is accessed, execution jumps to the first gadget. Each gadget does its small part and then returns, jumping to the next gadget address, and so on. The chain of gadgets can perform various functions, such as disabling security protections (e.g., making the stack executable), loading shellcode into a known location, and/or executing the shellcode.

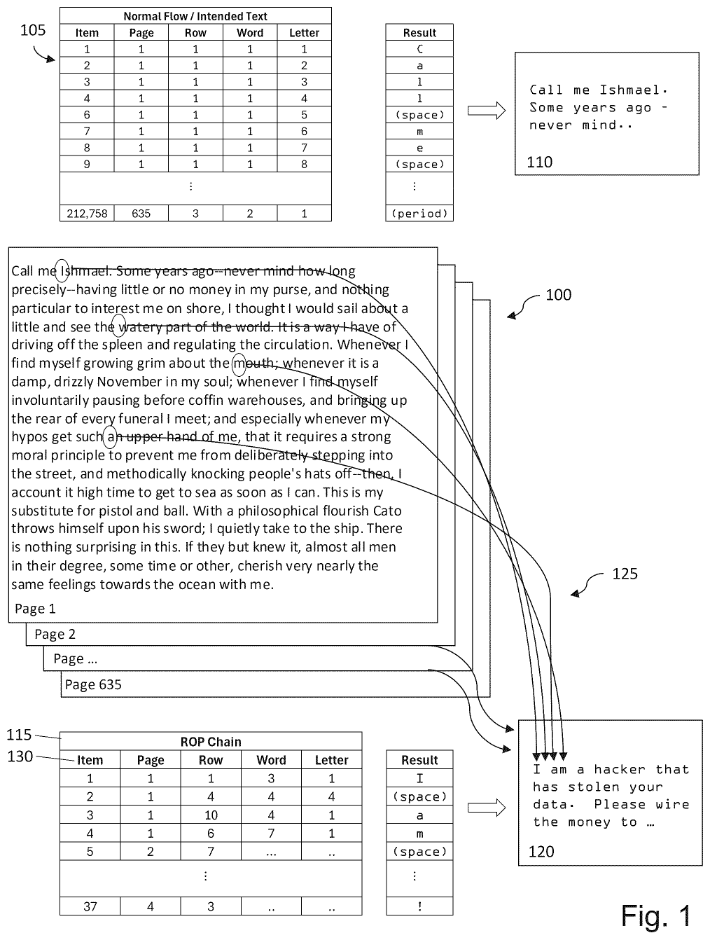

FIG. 1 illustrates an example memory safety exploitation analogy system to demonstrate the ROP attack employed by hackers to weaponize a memory safety vulnerability. For this style of attack to work, the attacker needs to have precise and detailed information about the contents of executable memory, including the specific memory addresses where various gadgets are located. For purposes of the analogy, the ROP gadgets are the letters and spaces in the text. The ROP chain comprises a series of ROP gadgets, arranged in a specific order to present nefarious results.

Block 100 depicts the sample of the text “Moby Dick”, as published by Harpers and Brothers on Nov. 14, 1851. When the text is read as intended by Herman Melville, as shown by block 105, the reader will begin at page 1, row 1, word 1, letter 1, as is customary in English writing. The intended message 110 begins with the “Call me Ishmael” and continues for the next 635 pages and 212,758 characters until finally ending with a period. The reader will then proceed sequentially from left-to-right, then top-to-bottom, with the book ending at the final line, final word, and final letter, on page 635. The flow of a normal reader is represented by block 105 where the pages, lines, words, and letters are analogous to the instructions that a computer is told to execute in a program.

In demonstrating a ROP attack in this analogy, block 115 represents an ROP chain and each item 130 of the ROP chain 115 is a call to an alternative letter or space from the source text. The process of retrieving the letters based on the location outlined by each item of block 115 are represented by arrows 125. The result of the ROP attack is depicted by the unauthorized message shown in block 120, crafted by strategically selecting and ordering legitimate words and letters from the source text to achieve a specific, unintended outcome. By stitching the letters of Moby Dick together in an unintended fashion, an attacker can create any English-language text they would like. In the presented scenario, the attacker has used ROP gadgets (specific letters from 100) to create a message that the user's data has been stolen and is being held for ransom.

For the ROP chain 115 to be meaningful, it can only be used with one specific edition of Moby Dick, the very first one published in the US, similar to how a specific version of software may be required for an ROP attack due to variations in memory layout between versions. Any other version of Moby Dick will have slightly different formatting with text appearing in different lines, paragraphs or pages. Any change in the layout would cause the alignment of text (which is analogous to the ROP gadget's position in memory) to likely result in an incoherent message. Thus, to create the ROP chain shown, the bad actor needs to have intimate knowledge of the original text to build the attack.

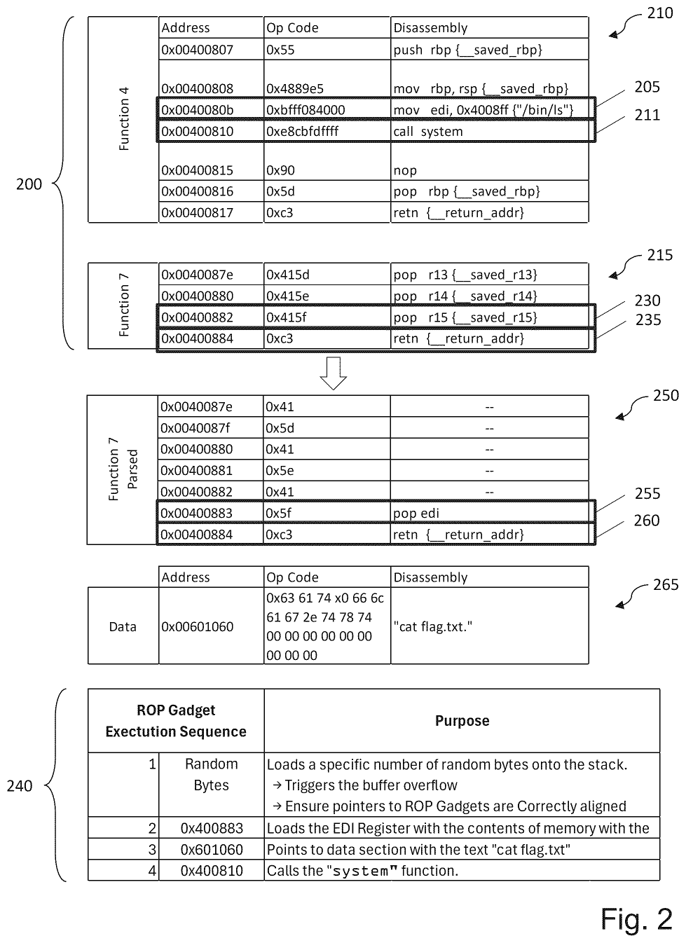

To demonstrate a real-world ROP attack, FIG. 2 illustrates a sample, abridged program 200 loaded into working memory. Program 200 is an x86-based ELF binary that is vulnerable to a buffer overflow attack. Two functions of the program (titled Function 4 and Function 7 are shown as code block 210 and 215). Each function in this example is made of several lines of assembly code. Each line of assembly code is shown as being disassembled from the Op Code (a.k.a. machine code) and the address in working memory where the machine code resides. It is important to reiterate that the assembly code shown is disassembled or derived from the machine code, that a line of assembly code may comprise one or more bytes, and that the address shown is dependent only on how the particular line of assembly code instruction is organized. In reality, the memory is fully addressable and there is a byte of information at each memory location. What is shown in Function 4 and Function 7 of FIG. 2 are the developers' intended design of the program 200.

Just like the in the example of “Moby Dick” with respect to FIG. 1, an attacker with intimate knowledge of the binary layout can predict the exact addressable location of specific lines of code which will be used as ROP gadgets. The ELF format is a standard file format used on Unix-like systems for binaries (e.g. executables, shared libraries, and object code). When the ELF based binary is loaded into memory, the header section of the ELF file provides system instructions which are used to link any calls to functions to the memory address where the function is loaded. Again, with intimate knowledge of the program and understanding of how the functions are loaded into memory, an attacker can identify specific lines of code to build ROP gadgets and link those gadgets together to create a ROP chain. The ROP chain 240 that targets the program is represented by a series of executable ROP gadgets numbered 1 through 4.

To demonstrate how an ROP attack on this program 200 may be accomplished the intended purpose of the functions shown can be compared with how the functions can be manipulated to perform unauthorized actions.

The first gadget identified includes two lines of instruction machine code existing in the working memory that are outlined as 205 and 211. As it was written by the developer, line 211 contains the “call system” instruction, and line 205 shows the intended arguments that would be passed to the call being loaded into the EDI register via a pointer. The ‘call system’ is used to execute a shell command from within the program and provides a simple way for the program to interact with the operating environment by issuing commands directly to the operating system's command processor. The intended argument which is passed via a pointer in the EDI register is a “Is” command (shown in the disassembly of line 205), which when passed to a system call, would display the contents of a directory.

With the location of the ‘call system’ known to the attacker, the attacker has direct access to system kernel and can perform tasks such as file management, process control, and communication. In this way, the attacker need only to build an ROP chain 240 which will manipulate the value at the EDI register to point to an alternative system command and then jump to line 211 to pass the argument via the EDI register to the system kernel.

A second gadget can be fabricated by deconstructing an intended command (i.e. command dissection). In this example, within function 7 (code block 215) are two instructions which the developer intended to originally ‘pop r15’ (line 230) and then proceed to ‘return’ (line 235). This command sequence would move the contents of the stack into register r15 and then return program flow from the function to the caller. As loaded into the working memory, the first instruction (in its intended state) places the machine code 0x4154 at address 0x00400882 and the return instruction having a machine code of 0xc34 at address 0x00400884. As noted, the machine code for the intended first instruction is a two-byte instruction. By having intimate knowledge of the program layout in memory, however, an attacker can reference the memory at address 0x00400883 where the machine code is just the single byte 0x54-which disassembles to the assembly code instruction ‘pop EDI’. The alternative version of Function 7 is shown as the “Function 7 Parsed” code block 250. So, the second gadget is established as the ‘pop edi’ (line 255) followed immediately by a return statement (line 260). The gadget will take information from the stack and place it into the EDI, effectively manipulating the data passed to system-level functions.

Additional gadgets may be identified using the approach identified above or may be injected into memory at specific points. As an example, there may be a sequential memory block set aside to hold a string, or any other type of memory struct. For this example, it will be presented that at a different point in the attack, the attacker managed to write several bytes to data memory (265), which will represent the unauthorized system call that will be accessed by the ROP chain, instead of the developer's intended instruction. The data memory block will be loaded with a string ‘cat flag. txt’, which will later be misused by the ROP chain to perform unauthorized actions. The command ‘cat flag.txt’ in a Unix-like operating system is used to display the contents of the file named flag.txt directly in the terminal (i.e. standard output).

The entire ROP chain is shown in block 240. With the program's buffer overflow vulnerability identified and the string ‘cat flag.txt’ in memory, the vulnerability is exploited, and the gadgets are carefully positioned and loaded onto the executable stack. Line-by-line, the ROP chain performs the following action described. First, line 1 of the ROP Chain 240 will trigger the buffer overflow and ensures the subsequent ROP gadgets are executed. This task may be accomplished by loading a specific number of random bytes onto the stack to trigger the buffer overflow and confirming the pointers of the ROP gadgets are correctly aligned on the stack to be processed as jump instructions.

Line 2 and Line 3 of the ROP Chain combine to create the second gadget which loads the EDI register with the pointer to the memory contents at 0x00601060. This is accomplished by first having the instruction on the stack to ‘pop EDI’, which subsequently grabs the next line as the memory address of the attacker's alternative system command.

With the EDI register pointing to the alternative system command, the attacker jumps to the first gadget identified-which was the ‘call system’. The call to the system function uses the parameter of the EDI register. The result is that the system performs the system command ‘cat flag.txt’, thereby displaying the entire contents of the ‘flag.txt’ to the display.

This is a devastating style of attack because the attacker can utilize the developer's own instructions against them, but it is also a fragile style of attack. Drawing off the analogy presented with regards to an attack on a specific edition layout of Moby Dick, where changes in the layout of the text will produce garbage, if the program changes at all, the ROP gadgets need to be completely rediscovered, and ROP chain developed. Unless the right circumstances exist, developing a ROP attack in mass is very difficult for an attacker to achieve.

This example reiterates an important premise of the implementations herein. Even if vulnerabilities are present in a binary, the ability to exploit the vulnerabilities is a separate technical question. This invention focuses measures of “exploitability” in a binary, regardless of the presence of vulnerabilities either known or unknown.

### Memory Safety Exploitability Analysis

To thwart attackers, according to some implementations, memory safety mitigation technology may be employed. Defenders have used randomization methods to defend against these attacks for many years, including tools like Address Space Layout Randomization (ASLR), which comes with many modern operating systems. ASLR randomizes the location of an application's code and data in memory, making it difficult for attackers to predict the address of particular functions or buffers, which is crucial for exploiting memory corruption vulnerabilities.

ASLR is a security technique employed at various stages and in different contexts to enhance system protection against exploitation, particularly from buffer overflow and other memory corruption vulnerabilities. The practice is utilized when binaries are moved from storage into working memory. This may occur during operating system initialization or when loading a specific application, executable binary, or shared library.

In the case of operating system initialization, during the boot-up process of an operating system, an enabled ASLR technique may remain active throughout the system's uptime, randomizing memory addresses used by system and application code. Alternatively, when enabled for a specific application, each time the binary starts, ASLR randomizes the base address of the executable and the positions of various memory segments like the stack, heap, and application libraries. ASLR can also randomize the load addresses of dynamic libraries (e.g., DLLs in Windows, .so files in Linux/Unix) so that whenever a new library is loaded at runtime, its base address is randomized. In all cases, ASLR ensures when an application begins execution, base addresses for the application will be at different physical addresses, thus significantly complicating attackers' attempts to predict memory locations and exploit memory corruption vulnerabilities.

Against modern advanced attack methods, however, one challenge that has been identified, namely, wherein ASLR does not provide enough granularity to defeat hackers. While the location of code is randomized, the order of that code is always the same from system to system, program launch to program launch. As a result, a single information leak can give attackers all the information they need to stitch together a reliable and effective exploit.

An alternative and more advanced method of memory safety mitigation technology is the Load-time Function Randomization (LFR) technique. According to some implementations, LFR is designed to enhance software security by randomizing the location of functions within a binary every time the binary is loaded into memory. This approach helps prevent attackers from predicting or knowing the memory layout of the application, which is crucial in defending against exploits that rely on such knowledge, like Return-Oriented Programming (ROP) attacks.

In some implementations, LFR technology works by inserting a small stub into the binary or shared object at compile time. This stub is linked with a library (e.g., LFRLib.so) that handles the randomization and patching of function locations just before the program begins execution. This randomization does not significantly affect the runtime performance of the application but enhances security by making it more difficult for attackers to exploit memory-based vulnerabilities. The adoption of LFR can be particularly beneficial in environments where software is challenging to update. By increasing memory diversity and disrupting the predictability of the memory layout, LFR effectively reduces the attack surface and mitigates the risk of memory corruption exploits without the need for frequent patches. According to some implementations, LFR technology represents a strategic approach to cybersecurity, offering a robust defense against zero-day and other memory-based vulnerabilities without the need to rewrite code in memory-safe languages, which can be costly and time-consuming. It provides a practical solution that can be quickly deployed across various industries, including critical infrastructure, military systems, and manufacturing, to protect against the exploitation of known and unknown vulnerabilities.

As stated previously, a 100% detection of memory safety vulnerabilities is rarely achievable even over years of testing. It is possible, however, to quantify the robustness of employed memory safety technologies or a binary protection scheme utilizing the methods and systems presented herein. At a high level, the method to quantify the effectiveness of a binary protection scheme involves performing an exploitation risk analysis of the binary before and after the protection scheme is applied. This practice may be employed, for example, by a developer who manufactures software or an end-user of products that utilize software such as a router.

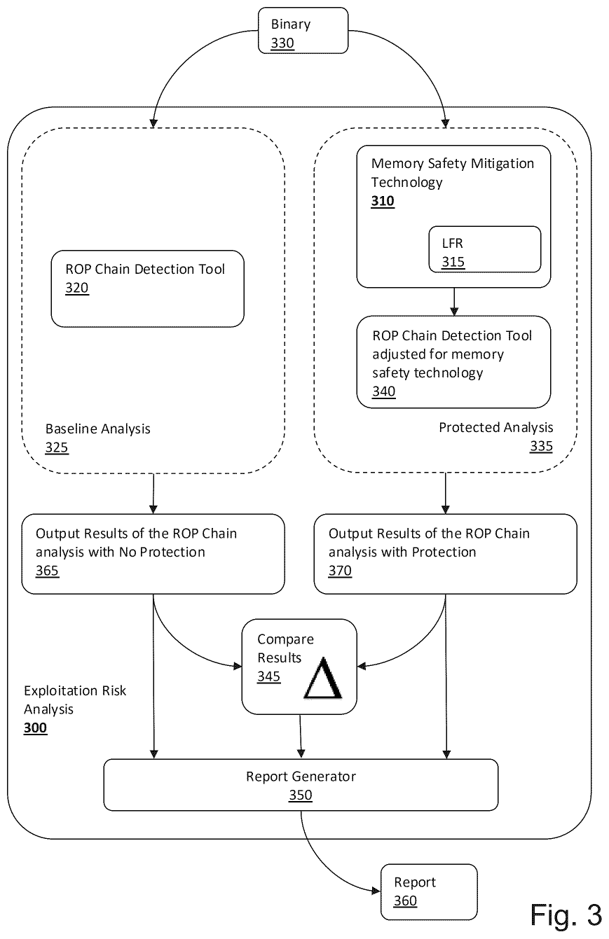

FIG. 3 illustrates an example system diagram of the components and use of the methods according to some implementations herein by analyzing a binary both with and without a memory safety mitigation technology being applied. The exploitation risk analysis system 300 comprises several key components that work together to assess and quantify the exploitability of memory safety vulnerabilities in binary programs. FIG. 3 illustrates an overview of the exploitation risk analysis system 300. The process begins with a binary 330 that undergoes two parallel analysis paths. In the first path, a baseline analysis 325 is performed using a ROP chain detection tool 320 to analyze the unprotected binary. The results of this analysis are captured as unprotected analysis results 365. In the second path, memory safety mitigation technology 310, which may comprise load function randomization 315, is applied to the binary. Following this, a protected analysis 335 is conducted using an adjusted ROP chain detection tool 340. The results are stored as protected analysis results 370. The process then moves to a results comparison 345, where the unprotected analysis results 365 and protected analysis results 370 are compared. The comparison data flows to a report generator 350, which produces a report 360 detailing the findings of the exploitation risk analysis 300. The process demonstrates a systematic approach to analyzing binary programs both with and without memory safety protections in place.

In some implementations, a ROP (Return-Oriented Programming) chain detection tool 320 is critical to identifying potential ROP attack vectors within executable binaries, both in environments with and without memory safety mitigation technology 310 which may include Load-time Function Randomization (LFR) 315.

In the absence of LFR or other randomization-based protection techniques, the memory addresses within an executable are static and predictable across program runs. In some implementations, a ROP chain detection tool 320 initially performs a baseline analysis 325 of the executable, scanning its binary form 330 to identify possible ROP gadgets-short sequences of machine instructions ending with a ‘return’ or ‘ret’ instruction-situated at fixed addresses. The tool then catalogs these gadgets and examines how data could potentially flow between them to detect sequences that might form usable ROP chains. When LFR 315 is enabled, the detection strategy must shift significantly towards protected analysis 335 as the base addresses of executables and libraries change with each execution, which is significantly more complex than the baseline analysis. The tool must then monitor the program during its runtime to observe the actual addresses in use and identify any patterns of gadget use that correspond to known or suspected ROP chains, utilizing protected analysis techniques to adapt to the randomized memory layout caused by LFR. This can involve instrumenting the code or utilizing hardware features to log memory and register accesses.

With the implementation of LFR, the tool also needs to adaptively and dynamically identify gadgets at runtime, recognizing sequences of instructions that function as gadgets in real-time as the program executes. Detection often relies on heuristics and anomaly detection techniques, such as looking for unusually frequent returns to non-standard addresses or suspicious sequences of stack manipulations that might indicate ROP activity.

Protected analysis and real-time gadget identification are computationally more intensive than the baseline analysis, posing a challenge in terms of the increased computational overhead and potential impact on the performance and responsiveness of the host system. Despite these challenges, LFR significantly enhances security by making the predictable exploitation of memory vulnerabilities more difficult, thus requiring ROP chain detection tools to leverage both baseline and protected analysis techniques to effectively adapt to modern computing environments. This balance between thoroughness and efficiency is crucial in the ongoing effort to protect systems from sophisticated ROP-based attacks.

In some implementations, the method of exploitation risk analysis 300 in cases where a memory safety technique is applied and the goal is to establish a quantifiable risk factor or at least assess risk with and without protection, comprises several components including a ROP Chain Detection tool 320, a memory safety mitigation technology 310 or technique, a mitigation-adjusted ROP chain detection tool 340, and a report generator 345. The function, purpose, and requirements for each tool follows.

A Return-Oriented Programming (ROP) chain detection tool 320 serves to identify complete ROP chains within a compiled binary. The main inputs for an ROP chain detection tool may include the binary 330 or executable code being analyzed, memory dumps from possibly compromised systems, execution traces documenting the sequence of executed instructions, and system or application logs that might provide clues about anomalous behavior or crashes. The outputs from a ROP chain detection tool typically encompass detection reports listing identified ROP gadgets and chains.

ROP detection tools require direct access to the binaries or the memory of running processes and are adept at recognizing patterns that signify ROP activity, which demands an in-depth understanding of the targeted processor architecture since ROP behaviors can vary across different architectures. Performance is a critical consideration, as real-time monitoring tools must operate efficiently to minimize system resource drain. Additionally, these tools need appropriate security permissions to access protected areas of the system's memory and process information.

Examples of such tools include ROPgadget, which allows for static analysis by searching through binaries to locate potential ROP gadgets; BinNavi, which provides capabilities for analyzing control flow graphs in binaries; Radare2, a comprehensive reverse engineering framework used for binary analysis; and the combination of GDB with PEDA, enhancing GDB's functionality to include searching for ROP gadgets in memory.

Memory Safety Mitigation Techniques 310 here are essentially treated as a ‘black box’ meaning the specific operational details are abstracted in this discussion, focusing instead on the outcomes of applying such techniques. Ergo it is sufficient to state that the technique under examination may be any method for protecting the binary from memory safety exploitation, such as control-flow integrity or a load-time function relocation (e.g. ASLR 315).

The ROP chain detection tool adjusted for memory safety mitigation technology 340, as the name describes, looks for ROP chains based on changes in the binary due after application of the applied memory safety mitigation technology. In some embodiments, the ROP Chain detection tool 320 and the ROP chain detection tool adjusted for memory safety mitigation technology 340 may be the same device, with tool behavior altered by configuration controls such as command-line arguments or settings in a configuration file.

An embodiment of a ROP chain detection tool adjusted for a memory safety mitigation technology would be a ROP chain detection tool designed to focus the identified ROP chain detection results to those inside of a function after load-time function randomization is applied to the binary. Load-time function randomization reshuffles the locations of functions in memory, preventing an attacker from knowing the absolute or relative location of ROP gadgets that aren't inside of a given function. Therefore, the attacker would need to find complete ROP chains that exist using only gadgets inside of a specific function.

As an input specific to the ROP Chain detection tool adjusted for memory safety technology 340, information relative to each function (a.k.a. estimated function data) may be derived. In the case where the binary has been protected by a memory safety technique such as ASLR, the metadata to identify function locations and sizes is present in the working memory of the loaded binary. In cases where the binary has not been protected by load-time function randomization, the information relative to each function (including location and size) can be determined using basic program analysis. In both cases, the estimated function data from program analysis would be used to set the function boundaries for load-time function randomization protected ROP chain analysis.

The report generator 345 combines the output of the multiple ROP chain analyses to create a report for a user (i.e. output). This report will highlight any changes in exploitation risk in the binary caused by adding the memory safety mitigation technology 310. In some implementations, a quantified result such as a rating may be presented. In some embodiments a detailed report may be presented. In some embodiments the specific format of the report and organization may be irrelevant (json, text, rtf, csv). In some embodiments, the report may be structured as an industry standard to be appended to a software BOM such as SPDX, Cyclone Dx, SWID, or NTIA. In some embodiments the report generator may be integrated in ROP Chain detection tool adjusted for memory safety mitigation.

Thus, in some implementations, the specific steps to perform a exploitation risk analysis process 300 include analyzing the binary 330 in working memory prior to memory safety mitigation technology and storing the output (output results of the ROP Chain analysis with No Protection 365), applying a memory safety mitigation technology 310 on the same binary 330 in working memory, performing a second ROP Chain Detection utilizing a tool adjusted for memory safety mitigation techniques (output results of the ROP Chain analysis with projection 370) and storing the output, analyzing the change 345 in the identified ROP chains existing in the outputs before and after the memory safety mitigation technique, and reporting the change the exploitation risk 360 via a report generator 350. A more detailed process is described in the text below.

In some implementations, the Exploitation Risk Analysis Process 300 is to analyze the binary 330 with no memory safety mitigation techniques for ROP chains. In this step the ROP Chain detection tool 320 is utilized for the analysis of potential ROP chains which may exist in the binary when no exploitation mitigation technology is present. In some implementations, the ROP chain analysis will produce an output which may include a list of ROP chains that can exploit the binary. The output or specifically the ‘output results of the ROP chain analysis with no protection’ 365 are stored for later comparison.

In some implementations, the Exploitation Risk Analysis Process 300 is to analyze the same binary 330 again after memory safety mitigation technologies 310 are applied. The step involves analysis of ROP chains utilizing the ROP chain detection tool adjusted for memory safety mitigation technology 340. To perform this task, the memory safety mitigation technology 310 is performed on the binary prior to the analysis. In some implementations, this step is repeated multiple times to provide Monte-Carlo type results as the memory safety mitigation technique may produce randomly generated outcomes or results. The ROP chain detection tool adjusted for memory safety mitigation technology 340 will produce an output which may include a list of ROP chains that can exploit the binary. The output or specifically the ‘output results of the ROP chain analysis with protection’ 370 are stored for later comparison.

In some implementations, the Exploitation Risk Analysis Process compares the output results 345 stored in previous steps. In some implementations, the comparison will look for similarities between the results from each step and the differences between the results from each step. In some implementations, the comparison will generate a report 360 via a report generator 350 which quantifiably assesses, amongst other things, the number of ROP chains reported in the output of the previous steps (i.e., the output of the ROP chain detection with and without memory safety mitigation techniques). In some implementations, the comparison will generate a report 360 identifying if the number of ROP chains increased, decreased, or stayed the same. In some implementations, the comparison will generate a report which states if there is there a meaningful (e.g., statistically significant) change in the content of the ROP chains and extrapolate a statement suggesting a decrease in exploitability.

In some implementations, of the Exploitation Risk Analysis Process, a user may extend the scope of the tool to analyze multiple binaries simultaneously. In this case, the exploitation risk analysis process would be performed on each binary before and after the application of memory safety mitigation techniques are employed to generate multiple output reports. In this embodiment the output reports may be aggregated across multiple binaries to describe an overall change in the exploitation risk.

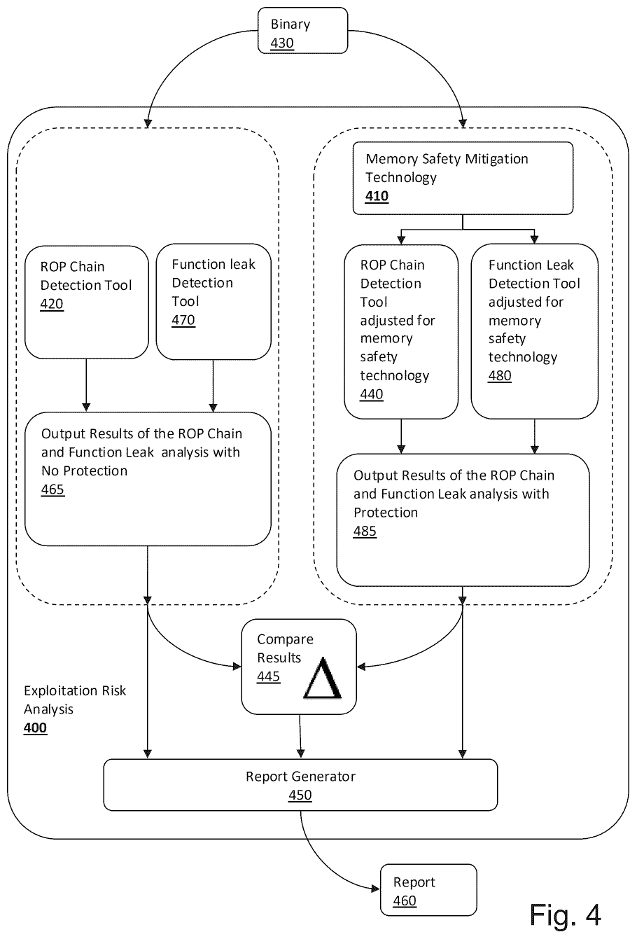

FIG. 4 illustrates an example extension of the Exploitation Risk Analysis process previously presented in FIG. 3, wherein the process further assesses risk based on function leak analysis. Function leak analysis involves detecting and analyzing leaks of sensitive function pointers, which could allow unauthorized access to or manipulation of program functions. During the analysis of the binary while performing the exploitation risk analysis process, a function may be identified that contains whole ROP chains or gadgets within the boundaries of the function (i.e. between the function header and the function footer). To state it differently, the function itself, if called by a hacker, may disclose sensitive information and/or lend itself to being weaponized. As such, if the address of the function is ‘leaked’ or identifiable by the binary, a strong case may be made that the program is at risk for exploitation.

Consider the function Publish_All_Social_Security_Numbers ( ) as a hypothetical example of a functional leak which could be exploited. This function is designed to transmit the social security numbers of all members in a database to a designated secure audit system for compliance checking. However, if misconfigured, such a function could inadvertently send this sensitive information to a public website. If an attacker discovered the location of this function due to a software flaw like a buffer overflow that leaks memory addresses, this would constitute a significant security risk, exemplifying a classic case of a function leak. This scenario underscores the importance of implementing memory safety mitigation techniques such as ASLR or LFR to protect sensitive functions from being exploited.

In some implementations, a binary may be analyzed to determine whether the address of a function may be leaked by code in the program. Alternatively, tools may be used that can help perform function leak analysis for languages such as C and C++, targeting various aspects of memory safety and security vulnerabilities including function pointer leaks. These tools generally include features to identify and mitigate risks associated with function leaks and other vulnerabilities. These tools could be used in place of or to complement the ROP Chain Detection Tools utilized in the Exploitation Risk Analysis Process.

This analysis will look for any use of function pointers or dynamically generated addresses that point to a function and then determine if there is a code flow path that would allow that address to be passed outside of the program. If the address is not leakable, then the exploitation risk of the complete ROP chain is non-existent and thus the resulting risk value is zero.

FIG. 4 shows the Exploitation Risk Analysis Process including both ROP Chain Detection and Leak Analysis Tools to test a binary before and after applying memory safety mitigation technology, such as LFR, and report the change in Exploitation Risk.

In some implementations, the first step of the Exploitation Risk Analysis Process 400 is to analyze the binary 430 with no memory safety mitigation techniques for ROP chains and function leakage. In this step, the ROP Chain detection tool 420 is utilized for the analysis of potential ROP chains, and a Function Leakage tool 470 is utilized for analysis of potential function leaks which may exist in the binary when no exploitation mitigation technology is present. In some implementations, the ROP chain analysis will produce an output 465 which may include a list of ROP chains that can exploit the binary. The function leak analysis will produce an output 475 which may include a list of detected leaks, potentially identifying sensitive function locations vulnerable to exploitation. The outputs are combined as the ‘output results of the ROP chain and function leak analysis with no protection’ 465 and are stored for later comparison.

The second step of the Exploitation Risk Analysis Process 400 is to analyze the same binary 430 again after memory safety mitigation technology 410 is applied. The step involves analysis of ROP chains utilizing the ROP chain detection tool 440 and analysis of function leaks utilizing the Function Leakage tool 480. In some implementations, both tools may be adjusted for memory safety mitigation technology. In order to perform this task, the memory safety mitigation protection may be performed on the binary prior to the analysis. In some cases, this step is repeated multiple times to provide Monte Carlo-type results as the memory safety mitigation technology like LFR may produce randomly generated outcomes or results, enhancing the robustness of the security analysis. The ROP chain detection tool adjusted for memory safety mitigation technology 440 will produce an output which may include a list of ROP chains that can exploit the binary. The function leak tool adjusted to memory safety mitigation technology will produce an output which may include a list of leaks which may identify sensitive function locations. In some implementations, the outputs are combined as the ‘output results of the ROP chain analysis and function leak analysis with protection’ 485 and are stored for later comparison. In some implementations, the method compares the output results 445 stored in previous steps. The comparison will look for similarities between the results from each step and the differences between the results from each step.

In some implementations, the comparison will generate a report 460 via a report generator 450 which quantifiably assesses, amongst other things, the number of ROP chains reported in the output of the previous steps (i.e., the output of the ROP chain detection with and without memory safety mitigation techniques). In some embodiments the comparison will generate a report identifying if the number of ROP chains increased, decreased, or stayed the same. In some embodiments the comparison will generate a report which states if there is there a meaningful change in the content of the ROP chains and will extrapolate a statement suggesting a decrease or increase in exploitability, based on the observed changes

In some implementations, the comparison will generate a report which quantifiably assesses, amongst other things, the number of function leaks reported in the output of the previous steps (i.e., the output of the ROP chain detection and function leaks both with and without memory safety mitigation techniques). In some implementations, the comparison will generate a report identifying if the number of function leaks increased, decreased, or stayed the same. In some implementations, the comparison will generate a report which states if there is a meaningful change in the content of the function leaks and will extrapolate a statement suggesting a decrease or increase in exploitability, based on the observed changes.

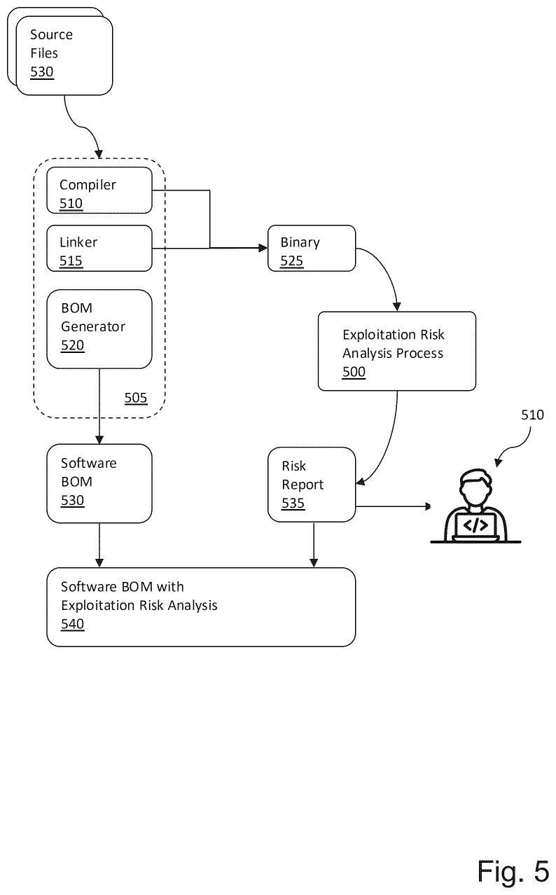

FIG. 5 presents an example alternative implementation of the Exploitation Risk Analysis 500 being tied into a developers build process. Also shown is the Risk Report 535 of the Exploitation Risk Analysis 500 being integrated into a Software BOM. When the Exploitation Risk Analysis tied into a software build process, the developer may incorporate closed-loop improvements by addressing exploitation risk as part of an ongoing process improvement. The exploitation risk analysis process may be performed during the development (SAST, DAST, etc.), to provide comprehensive statistics about zero-day risk in build artifacts.

As a closed loop system, in some implementations, the developer 510 creates the source files 530. The source files are compiled 510 and/or linked 515 as part of a standard build process 505. In some implementations, the output of the build process are the binary file(s) 525 which are passed into the Exploitation Risk Analysis Process 500. In some implementations, the Exploitation Risk Analysis Process 500 creates a risk report which is then available to the developer 510. The developer may use this information as a metric to take an action with regards to the source file (i.e. approve, publish, reject changes, etc.)

FIG. 5 also shows the Exploitation Risk Analysis tied into a software bill of materials (SBOM) analysis process. Typical content reported during an SBOM process is the list of raw ingredients that went into making the image, such as libraries, packages, and their respective version numbers, etc. By including the exploitation risk analysis, the SBOM report would include not just information about known vulnerabilities but also risks pertaining to potential exploitation of binaries and the image via as-yet-undiscovered vulnerabilities. The user would be able to understand the risk associated with and without the inclusion of memory safety mitigation technology in the image.

As shown in FIG. 5, a software Bill of Material generator 520 may be part of the build process 505 concurrently create a Software BOM 530 while creating the binary file 525. The Software BOM may also be generated outside of the build process using pre-build or post-build development tools. In either case, the software BOM 530 may be combined with the Risk Report 535 to create a Software BOM with Exploitation Risk Analysis 540.

### Computer System

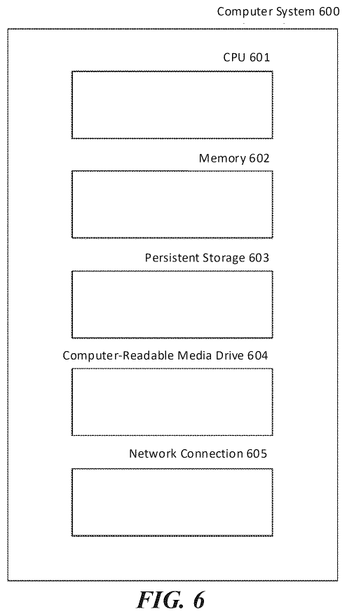

FIG. 6 is a block diagram showing some of the components typically incorporated in at least some of the computer systems and other devices on which the disclosed system operates. In various embodiments, these computer systems, and other devices 600 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (CPU) 601 for executing computer programs; a computer memory 602 for storing programs and data while they are being used, including the facility and associated data, an operating system including a kernel, and device drivers; a persistent storage device 603, such as a hard drive or flash drive for persistently storing programs and data; computer-readable media drives 604 that are tangible storage means that do not include a transitory, propagating signal, such as a floppy, CD-ROM, or DVD drive, for reading programs and data stored on a computer-readable medium; and a network connection 605 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations and having various components.

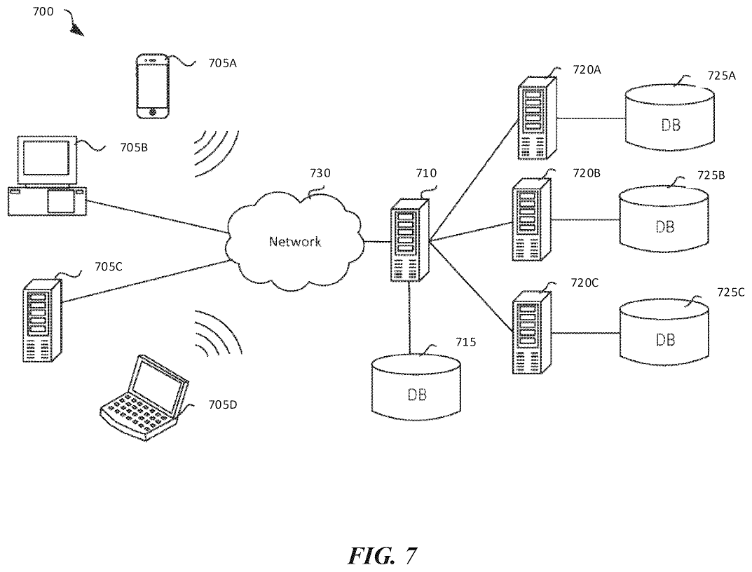

FIG. 7 is a system diagram illustrating an example of a computing environment in which the disclosed system operates in some embodiments. In some embodiments, environment 700 includes one or more client computing devices 705A-D, examples of which can host the system 600. Client computing devices 705 operate in a networked environment using logical connections through network 730 to one or more remote computers, such as a server computing device.

In some embodiments, server 710 is an edge server which receives client requests and coordinates fulfillment of those requests through other servers, such as servers 720A-C. In some embodiments, server computing devices 710 and 720 comprise computing systems, such as the system 100. Though each server computing device 710 and 720 is displayed logically as a single server, server computing devices can each be a distributed computing environment encompassing multiple computing devices located at the same or at geographically disparate physical locations. In some embodiments, each server 720 corresponds to a group of servers.

Client computing devices 705 and server computing devices 710 and 720 can each act as a server or client to other server or client devices. In some embodiments, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as home information, recent sales, home attributes, and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN) but can also be other wired or wireless networks. In some embodiments, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

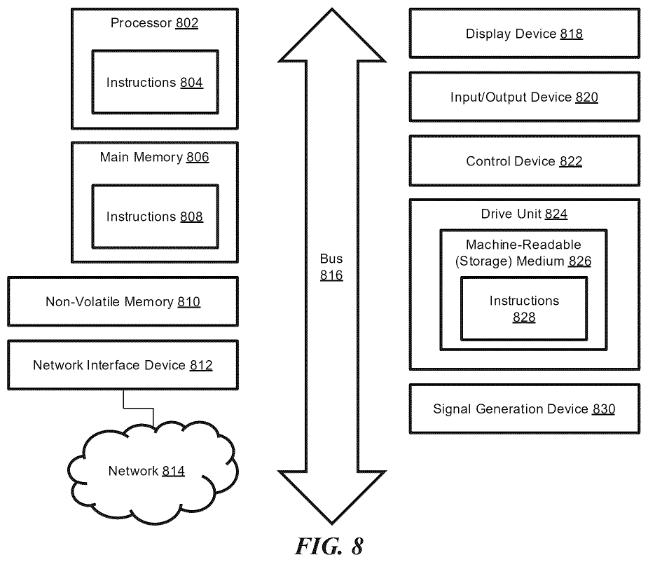

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for determining exploitability of memory safety vulnerabilities, the computer-implemented method comprising:
analyzing, by a computer system, a first executable by scanning a binary of the first executable to identify one or more first sequences of instructions ending with a return instruction, each first sequence of instructions situated at a fixed memory address;
analyzing, by the computer system, the one or more sequences of machine instructions to detect one or more usable sequences in a Return Oriented Programming (ROP) chain;
monitoring, by the computer system, a second executable during runtime of the second executable to identify at least one pattern corresponding to a known or suspected ROP chain, wherein the second executable comprises the first executable augmented with code comprising one or more memory safety mitigation technologies;
identifying, by the computer system based at least in part on the at least one pattern, one or more second sequences of instructions during runtime of the second executable;
comparing, by the computer system, the one or more first sequences with the one or more second sequences;
calculating, by the computer system based on the comparison, a change in exploitation risk between the first executable and the second executable; and
generating, by the computer system, a report including the calculated change in exploitation risk between the first executable and the second executable, wherein the computer system comprises a processor and a memory.

2. The computer-implemented method of claim 1, wherein the monitoring of the second executable comprises instrumenting a code of the second executable or using hardware features to log memory and/or register accesses of the second executable.

3. The computer-implemented method of claim 1, wherein the one or more memory safety mitigation technologies comprises Load-time Function Randomization (LFR).

4. The computer-implemented method of claim 1, further comprising converting the calculated change in exploitation risk into a rating.

5. The computer-implemented method of claim 1, further comprising:
identifying one or more dynamically generated addresses that point to a function within the first executable; and
determining whether there is a code flow path through the first executable that would allow the one or more dynamically generated addresses to be passed outside of the first executable.

6. The computer-implemented method of claim 1, further comprising:
identifying one or more dynamically generated addresses that point to a function within the second executable; and
determining whether there is a code flow path through the first executable that would allow the one or more dynamically generated addresses to be passed outside of the second executable.

7. The computer-implemented method of claim 1, wherein one or more of the method steps are repeated multiple times to provide Monte Carlo-type results.

8. The computer-implemented method of claim 1, wherein the report comprises a number of the one or more first sequences and a number of the one or more second sequences.

9. The computer-implemented method of claim 1, further comprising including the report in a software bill of materials (SBOM).

10. A system, comprising:
at least one hardware processor; and
at least one non-transitory memory storing instructions that, when executed by the at least one hardware processor, cause the system to:
analyze a first executable by scanning a binary of the first executable to identify one or more first sequences of instructions ending with a return instruction, each first sequence of instructions situated at a fixed memory address;
analyze the one or more sequences of machine instructions to detect one or more usable sequences in a Return Oriented Programming (ROP) chain;
monitor a second executable during runtime of the second executable to identify at least one pattern corresponding to a known or suspected ROP chain, wherein the second executable comprises the first executable augmented with code comprising one or more memory safety mitigation technologies;
identify, based at least in part on the at least one pattern, one or more second sequences of instructions during runtime of the second executable;
compare the one or more first sequences with the one or more second sequences;
calculate based on the comparison, a change in exploitation risk between the first executable and the second executable; and
generate a report including the calculated change in exploitation risk between the first executable and the second executable.

11. The system of claim 10, wherein the system is further caused to include the report in a software bill of materials (SBOM).

12. A non-transitory, computer-readable storage medium comprising instructions recorded thereon, wherein the instructions, when executed by at least one data processor of a system, cause the system to:
analyze a first executable by scanning a binary of the first executable to identify one or more first sequences of instructions ending with a return instruction, each first sequence of instructions situated at a fixed memory address;
analyze the one or more sequences of machine instructions to detect one or more usable sequences in a Return Oriented Programming (ROP) chain;
monitor a second executable during runtime of the second executable to identify at least one pattern corresponding to a known or suspected ROP chain, wherein the second executable comprises the first executable augmented with code comprising one or more memory safety mitigation technologies;
identify, based at least in part on the at least one pattern, one or more second sequences of instructions during runtime of the second executable;
compare the one or more first sequences with the one or more second sequences;
calculate based on the comparison, a change in exploitation risk between the first executable and the second executable; and
generate a report including the calculated change in exploitation risk between the first executable and the second executable.

13. The non-transitory, computer readable storage of claim 12, wherein the monitoring of the second executable comprises instrumenting a code of the second executable or using hardware features to log memory and/or register accesses of the second executable.

14. The non-transitory, computer readable storage of claim 12, wherein the one or more memory safety mitigation technologies comprises Load-time Function Randomization (LFR).

15. The non-transitory, computer readable storage of claim 12, wherein the system is further caused to convert the calculated change in exploitation risk into a rating.

16. The non-transitory, computer readable storage of claim 12, wherein the system is further caused to:
identify one or more dynamically generated addresses that point to a function within the first executable; and
determine whether there is a code flow path through the first executable that would allow the one or more dynamically generated addresses to be passed outside of the first executable.

17. The non-transitory, computer readable storage of claim 12, wherein the system is further caused to:
identify one or more dynamically generated addresses that point to a function within the second executable; and
determine whether there is a code flow path through the first executable that would allow the one or more dynamically generated addresses to be passed outside of the second executable.

18. The non-transitory, computer readable storage of claim 12, wherein one or more of the steps are repeated multiple times to provide Monte Carlo-type results.

19. The non-transitory, computer readable storage of claim 12, wherein the report comprises a number of the one or more first sequences and a number of the one or more second sequences.

20. The non-transitory, computer readable storage of claim 12, wherein the system is further caused to include the report in a software bill of materials (SBOM).
